(19) United States
(12) Patent Application Publication
(10) Pub. No.: US 2022/0207565 A1
(43) Pub. Date: Jun. 30, 2022

(54) IN-VEHICLE CONTEXTUAL PROMOTIONS

(71) Applicant: Sirius XM Connected Vehicle Services Inc., Irving, TX (US)

(72) Inventors: William Mitchell Dornich, Copper Canyon, TX (US); John Jasper, Lantana, TX (US); Paul Doucette, Allen, TX (US); Victoria Repice, Southlake, TX (US); Marti Gold, Allen, TX (US)

(21) Appl. No.: 17/531,214

(22) Filed: Nov. 19, 2021

Related U.S. Application Data
(63) Continuation-in-part of application No. 17/143,136, filed on Jan. 6, 2021, now abandoned.
(60) Provisional application No. 62/957,711, filed on Jan. 6, 2020.

(51) Int. Cl. G06Q 30/02; G06Q 20/36; G01C 21/34

(52) U.S. Cl. CPC G06Q 30/0265; G01C 21/34; G06Q 20/3674; G06Q 20/367

(57) ABSTRACT

Methods for in-vehicle contextual promotions are described herein. In a first method a driver receives an in-vehicle promotion (for either food or fuel) based on a time of day, their location, route, favorite items, favorite vendors, and nearby vendors. The driver taps the promotion and receives a list of favorite items. The driver makes a selection of the favorite items, makes a payment for the selected product using an e-wallet, and picks up the selected product. In a second method, the driver may receive an in-vehicle promotion, including a “remind me later” link. When the user taps on the link, they may then access the promotion at a later time on their mobile phone app outside of the vehicle. The user taps on the saved link and is redirected to a vendor's website. The user may make a purchase for a product at the vendor's website at this later time.

### CROSS REFERENCE TO RELATED APPLICATIONS

This application is a continuation-in-part of U.S. patent application Ser. No. 17/143,136, filed Jan. 6, 2021, which claims priority to and the benefit of U.S. Provisional Application No. 62/957,711, filed Jan. 6, 2020, the contents of which is incorporated herein by reference in its entirety.

### FIELD OF INVENTION

This application is in the field of in-vehicle services.

### SUMMARY

Methods and a system for in-vehicle contextual promotions are described herein. In a first method, described herein, a driver may receive an in-vehicle promotion for businesses along a driving route. In a second method, described herein, a driver may transmit a reminder to the driver's mobile phone to visit an as advertised website at a time after the driver is out of the vehicle.

In a first example method, a driver may receive an in-vehicle promotion, wherein the promotion is based on a driver's route and driver-defined favorite vendors. The driver may then tap on the in-vehicle promotion and receive a list of menu items. For example, the menu items may include a list of the driver's favorite or recently ordered items. The driver may then make a selection of at least one of the favorite items. The driver may then make a payment for the product selection using an e-wallet and picks up the selected product. Additionally, the driver may receive loyalty rewards for their in-vehicle purchase.

In a second example method, the driver may receive an in-vehicle promotion, wherein the promotion includes a “remind me later” link. The driver may then tap on the “remind me later” link. At a later time, the driver may access a Marketplace in a user's phone app. The user may tap on at least one of the “remind me later” links and may then be redirected to a vendor's website. The user may then make a purchase for a product at the vendor's website.

The system may be coupled to in-vehicle media, for example, 360L

The system may be integrated with a navigation system to facilitate a better and safer driving experience for in-car offers.

The system may leverage voice as part of the experience to minimize distracted driving and create a better user experience.

The system may support direct service types such as fuel, parking and food. Additionally, the system may support a wide range of other services such as Original Equipment Manufacturer (OEM) services or a push to “remind later” services that might be related to an audio advertisement which the audio system presents (for example, Boll and Branch).

### BRIEF DESCRIPTION OF THE DRAWINGS

FIG. 1 is an example of an in-vehicle contextual alert;

FIG. 2 is an example of an order overlay;

FIG. 3 is an example vendor order screen;

FIG. 4 is an example of an e-wallet screen with the driver's payment options;

FIG. 5 is an example of payment confirmation and route update screen;

FIG. 6 is an example of an arrival screen;

FIG. 7 is an example of a thank you and loyalty program screen;

FIG. 8 is an example method of receiving and utilizing in-vehicle promotions;

FIG. 9 is an example of a “send a reminder to my phone” link;

FIG. 10 is an example screen illustrating that a reminder has been successfully sent;

FIG. 11 is an example home page of the mobile phone app with Marketplace reminder alerts;

FIG. 12 is an example of Marketplace reminders;

FIG. 13 is an example screen of successfully navigating to a vendor's mobile website;

FIG. 14 example method of receiving an in-vehicle promotion including a “remind me later” link;

FIG. 15 is an example scope diagram;

FIG. 16 is a first example flow diagram of a contextual promotion followed by an in-vehicle purchase;

FIG. 17 is a second example flow diagram of contextual promotion followed by an in-vehicle purchase;

FIG. 18 is an example flow diagram of a contextual promotion followed by a “remind me later” link; and

FIG. 19 is an example flow diagram of a “remind me later” purchase.

### DETAILED DESCRIPTION OF THE DRAWINGS

Methods and a system for in-vehicle contextual promotions are described herein. In a first method, a driver may receive an in-vehicle promotion for businesses along a driving route. In a second method, a driver may be able to transmit a reminder, to the driver's mobile phone, to visit an as advertised website at a time after the driver is out of the vehicle.

In a first embodiment, a driver, or user, may activate the navigation system of a vehicle and enter a particular destination. When the navigation system is activated, a cloud system may run a search and pull coordinates for all user-defined favorites and loyalty linked vendors along the selected route. For example, user-defined favorites and loyalty linked vendors may include both food and beverage vendors, such as Starbucks, Panera, and the like.

Each vendor may have a predefined proximity range. For example, when a driver is within a 10 mile radius of a participating vendor. Once the driver's vehicle reaches the predefined proximity range, the radio may resend a target message. The vendor may use the radio to present the message to the driver, in context and unobtrusively, as the driver approaches a favorite store or destination along their route.

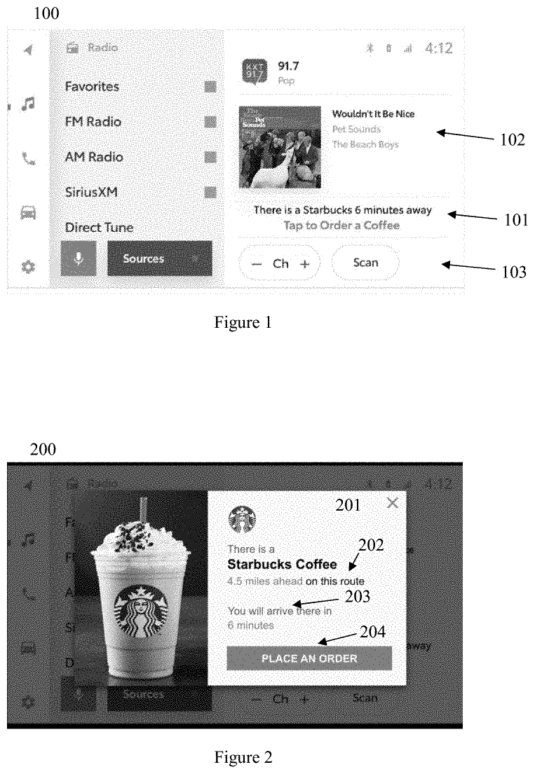

FIG. 1 is an example of an in-vehicle contextual alert. The contextual alert 101 may identify that a Starbucks is six (6) minutes away. The contextual alert 101 may be shown as a message just below the song information 102 and just above the radio options 103. As illustrated in FIG. 1, the contextual alert 101 does not interfere with the other information on the radio screen 100.

On a condition that the user taps the contextual alert, the radio may display an overlay that contains information for the vendor. For example, the information may include time and distance to reach the vendor, a promotional offer, an option to order, and the like.

FIG. 2 is an example of an order overlay. The order overlay 201 may appear over the radio screen 200. The order overlay 201 may identify that there is, for example, a Starbucks Coffee 4.5 miles ahead 202 on the route the driver is traveling. The order overlay 201 may further indicate that it takes 6 minutes to arrive 203. The order overlay 201 may allow a driver to place an order by pressing the place an order button 204.

The driver may then be taken directly to the vendor's order screen. The default view may be the driver's favorite items or the most recently ordered items from that vendor. Alternatively, if the driver is interested in a different item than their favorites or most recently ordered, the vendor's full menu may also be easily accessible.

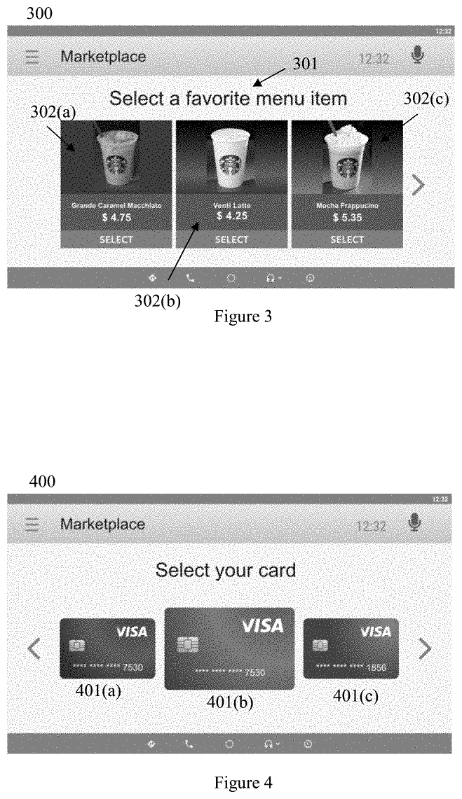

FIG. 3 is an example vendor order screen. The vendor order screen 300 includes a driver's favorite menu items 301. Once the driver presses the place an order button (203 in FIG. 2), a menu 301 of the user's favorite items may open. The driver may then easily select an option 302(a), 302(b), or 302(c) for ordering.

Once the driver makes a selection, the driver may then access their electronic wallet (or e-wallet), based on the vehicle. For example, access to the driver's wallet may include a personal identification number (PIN), touch, biometrics, or any other convenient method. Active credit cards may be visually prominent.

FIG. 4 is an example of an e-wallet screen with the driver's payment options. The driver may be prompted to select a card 401(a), 401(b), or 401(c), from the driver's e-wallet screen 400. The driver may then confirm payment.

Once the driver confirms payment, the screen may then display the user's order confirmation with receipt information. The screen may also display any minor navigation updates to reach the location of the vendor.

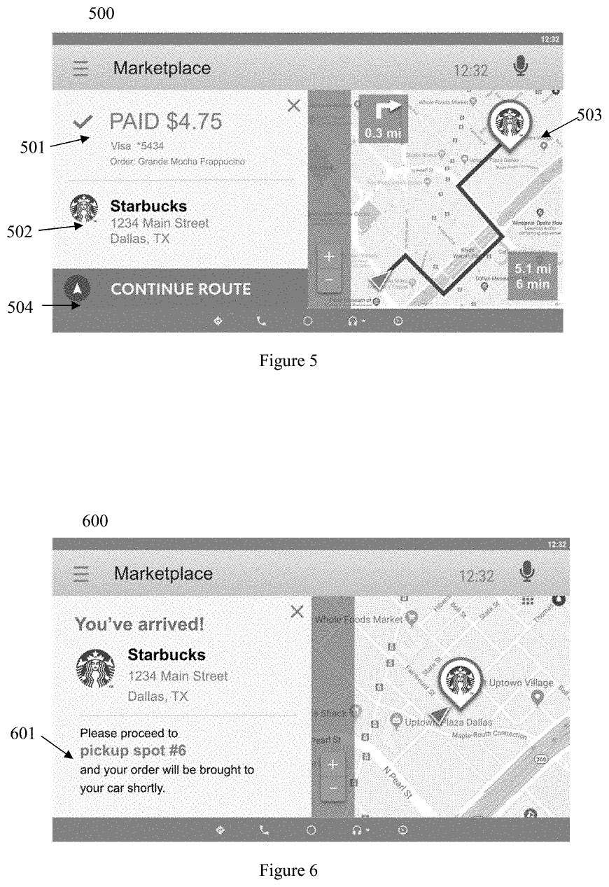

FIG. 5 is an example of a payment confirmation and route update screen. The payment confirmation and route update screen 500 may include a paid receipt 501, a store name and address, 502, and a route update 503 for reaching the desired location. The driver may select the continue route button 504 to follow the suggested route update 503.

As the car approaches the vendor, a message, for example, “you've arrived,” may be displayed with instructions on how to pick up the user's order. The message may appear once a geo-fence of the vendor is broken by the driver's car. This may also serve as an indication to the vendor that the driver has arrived to retrieve their order.

FIG. 6 is an example of an arrival screen. The arrival screen 600 may include details for where the drive should park their car for pickup services 601.

After the driver picks up their order, all transaction data (for example, timestamp, vendor name and location, item information, price, and the like) may be transmitted to the Original Equipment Manufacturer's (OEM's) Marketplace database or cloud for reconciliation. Once the order is completed, for example, the order has been received, information about the transaction may be sent to the respective loyalty program and the driver is alerted.

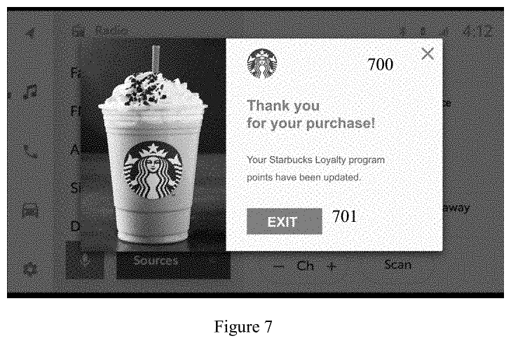

FIG. 7 is an example of a thank you and loyalty program screen. A pop-up 700 may appear on the screen to thank the driver for their purchase. The pop-up screen may also indicate that the driver has received loyalty points for their purchase. The driver may then press exit 701 to return to the original radio screen.

The system described herein may ensure that drivers receive and use valuable loyalty program points and discounts. The system may also provide drivers with the ability to instantly sign up for new loyalty programs from a head unit or from within the SiriusXM app.

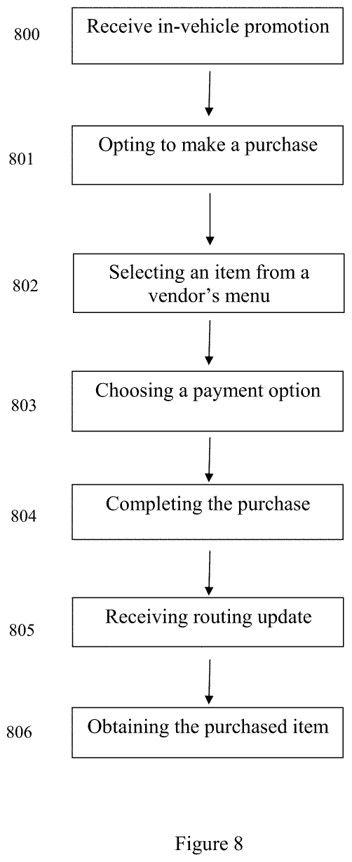

FIG. 8 is an example method of receiving and utilizing in-vehicle promotions. A driver may receive an in-vehicle promotion from a vendor along a predetermined route 800. The driver may then choose to make a purchase based on the received promotion 801. On a condition that the driver chooses to make a purchase, a menu screen appears. The menu screen may include the driver's favorite or recently purchased items. The driver may then make a selection from the menu screen 802. Once the driver makes a selection, an e-wallet screen appears. The driver may select from one of several credit cards in the e-wallet 803. Once the driver has selected a credit card, the driver may then receive a paid confirmation 804 and routing instructions 805. After the driver has passed through a geo-fence of the vendor, instructions for pickup services will appear. Once the driver has received their desired item 806, a pop-up may appear to thank the driver for their purchase. On a condition that the desired vendor has a loyalty rewards program, the driver's account may be updated with any loyalty rewards.

In a second embodiment, vendors participating in an OEM Marketplace may display a “send a reminder to my phone” link in addition to normally shown advertisement information on a radio screen. For example, normally shown advertisement information may include a vendor's name and website.

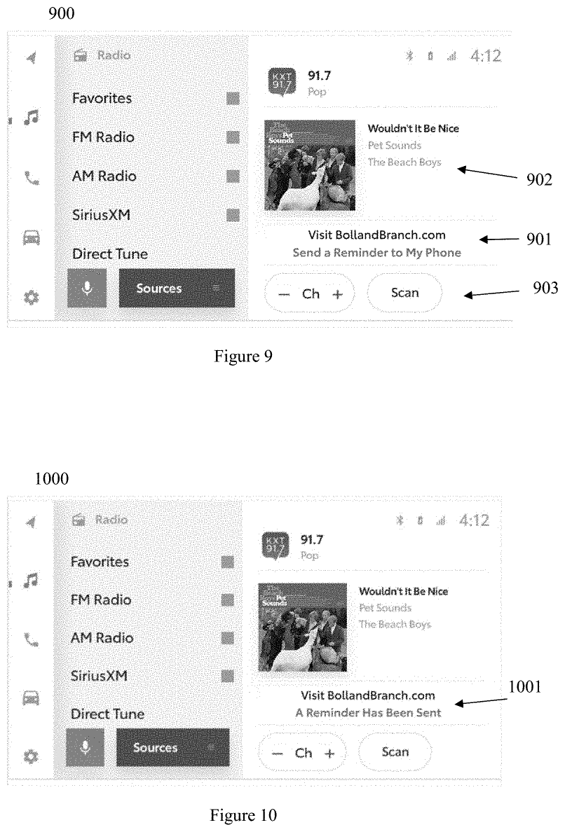

FIG. 9 is an example of a “send a reminder to my phone” link. A “send a reminder to my phone” link 901 may appear on a radio screen 900 as a reminder for a driver to go to an advertised website, for example, visit BollandBranch.com, at a later time. The “send a reminder to my phone” link 901 may be shown as a message just below the song information 902 and just above the radio options 903. As shown in FIG. 9, the “send a reminder to my phone” link 901 does not interfere with the other information on the radio screen 900.

The driver may then tap the “send reminder to my phone” link. When the message is tapped, the system may send all relevant driver and advertiser information to the driver's OEM Owner's account. This information will appear the next time the driver logs into their mobile application.

FIG. 10 is an example of a message illustrating that a reminder has been successfully sent. The radio screen 1000 may now show that a reminder has been sent 1001.

At some time later, after the driver has exited the vehicle, the driver may log into a mobile phone app, for example the SiriusXM app. The driver may see links and alerts for Marketplace (in addition to the vehicle status and service sections) in the mobile phone app.

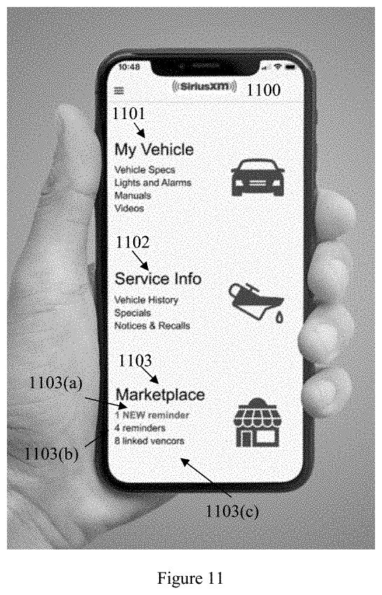

FIG. 11 is an example home page of the mobile phone app with Marketplace reminder alerts. The home page of the mobile phone app 1100 may include a my vehicle section 1101, a service info section 1102, and a marketplace section 1103. In the marketplace section 1103, the user may notice at least 1 new reminder 1103(a), other reminders 1103(b), and linked vendors 1103(c).

The user may then tap the Marketplace reminders. Once the Marketplace reminders are open, the driver may see a scrollable list of all saved reminders. Each time the driver taps the “send me a reminder” link, the vendor and timestamp information is sent to the reminder list. This may permit the driver to access any saved vendor and safely make a purchase.

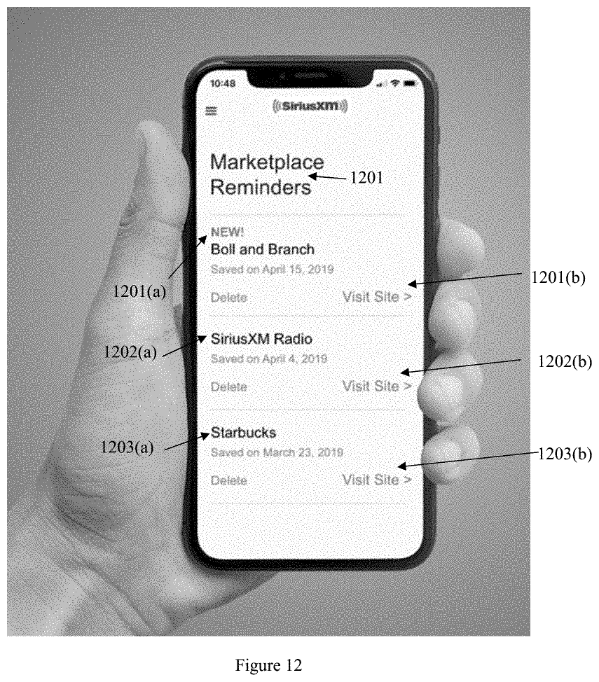

FIG. 12 is an example of Marketplace reminders. The marketplace reminders 1201 may include the new reminder 1201(a), for example, for Boll and Branch, and a link to visit the website 1201(b). The marketplace reminders 1101 may also include older reminders 1202(a) and 1203(a), for example, Sirius XM Radio and Starbucks, and a link to visit those websites 1202(b) and 1203(b).

Once the user clicks on the appropriate link, the user is taken to the vendor's mobile website to safely make purchases. The Marketplace system may add tags to the Uniform Resource Locator (URL) ensuring accurate tracking and revenue credits.

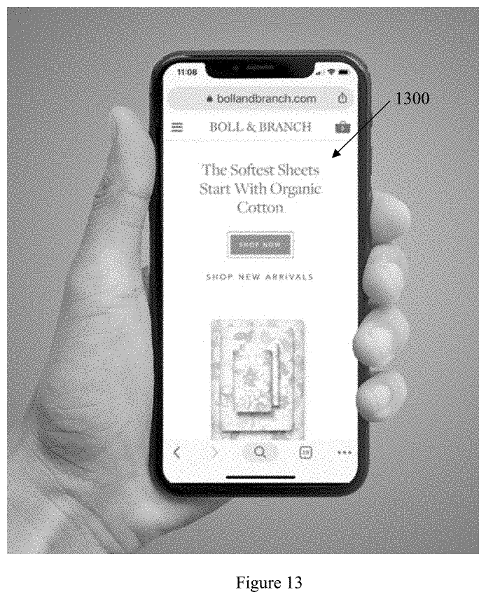

FIG. 13 is an example screen of successfully navigating to a vendor's mobile website. The vendor's mobile website 1300 may appear on the user's mobile phone in response to clicking the visit site button (1201(a) shown in FIG. 12).

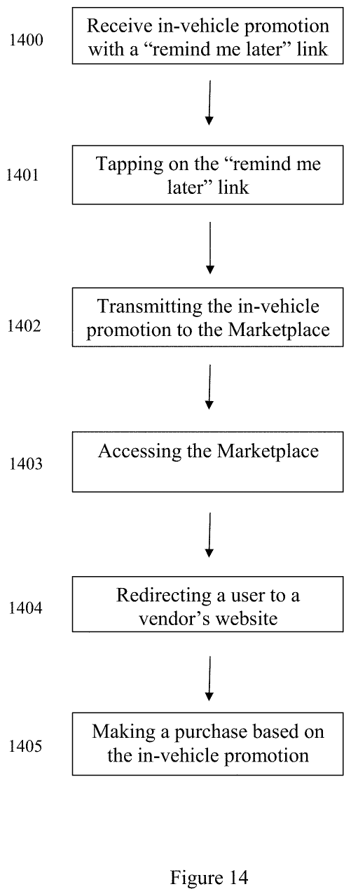

FIG. 14 is an example method of receiving an in-vehicle promotion including a “remind me later” link. The user may receive an in-vehicle promotion including a “remind me later” link from a vendor participating in a Marketplace 1400. The user may then tap on the “remind me later” link 1401. By clicking this link, the in-vehicle promotion is transmitted to the Marketplace 1402. At a later time, the user may access the Marketplace of a phone app of the user 1403. The user may tap on at least one of the “remind me later” links and is then redirected to a vendor's website 1404. The user may then make a purchase for a product at the vendor's website based on the received in-vehicle promotion 1405.

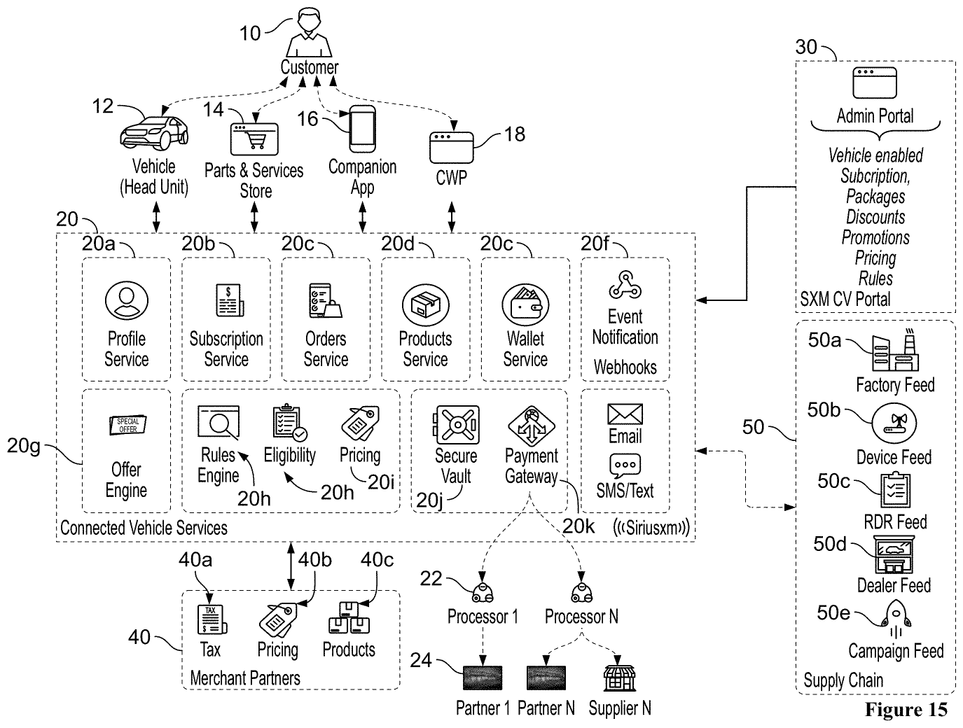

FIG. 15 is an example scope diagram. A user 10 may be the driver or a passenger in a vehicle. The user 10 may utilize at least one frontend to interact with the connected vehicle services 20. The connected vehicle services 20 may communicated with a SXM CV portal 30, merchant partners 40, and a supply chain 50.

The frontend may be a vehicle head unit 12, a web store 14, a companion app 16, and a web portal 18. The vehicle may be equipped with a head unit or the user may have a mobile device. The head unit or mobile device may be running the contextual promotions application.

The connected vehicle services 20 may include a profile service 20a, a subscription service 20b, an orders service 20c, a products service 20d, a wallet service 20e, an event notification 20f, an offer engine 20g, a rules and eligibility engine 20h, a pricing engine 20i, a secure vault 20j, and a payment gateway 20k. The profile service 20a may provide the user 10 with access to other microservices and store a user's preferences, favorites, and usage data. The subscription service 20b may track and initiate monthly/annual subscription payments using the wallet. The orders service 20c may orchestrate the ordering and payment process with the merchant partners 40. The products service 20d may manage and normalize the product and menu catalogs of the merchant partners 40 into a single unified product catalog. The wallet service 20e may store user payment tokens used in subscription and order services 20b and 20c. The event notification 20f may be a notification service to the customer frontends, for example, an order status, receipts, and the like. The offer engine 20g may be responsible for creating and notifying users of contextually-relevant, commerce-related offers. The rules and eligibility engine 20h may establish service eligibility of a user 10. The pricing engine 20i may manage pricing for SiriusXM products. The secure vault 20j may securely capture and store the user's credit card(s) information. The payment gateway 20k may route user payment tokens to the appropriate payment processor of the merchant.

The payment gateway 20k may communication with several processors, for example, a first processor 22. The first processor 22 may communicate with a first partner 24.

The SXM CV portal 30 may be the administrative portal for the platform. The SXM CV portal 30 may include vehicle enabled subscription, package discounts, promotions, pricing, rules, and the like.

The merchant partners 40 may provide non-SXM good and services, for example, food, fuel, and parking. The merchant partners may include tax 40a, pricing 40b, and products, 40c.

The supply chain 50 may contain data feeds from OEM partners related to vehicle configuration and capabilities. The supply chain 50 may include a factory feed 50a, a device feed 50b, an RDR feed 50c, a dealer-feed 50d, and a campaign feed 50e.

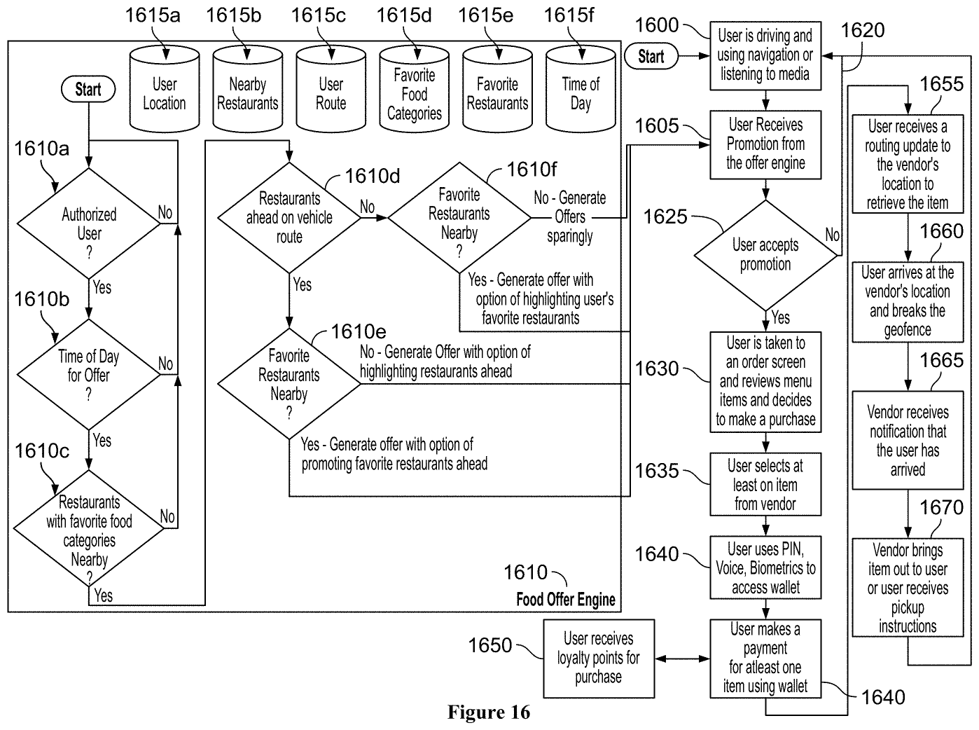

FIG. 16 is a first example flow diagram of a contextual promotion followed by an in-vehicle purchase. A driver may be driving and using the navigation or listening to media 1600. The driver may receive a promotion from an offer engine 1605. In FIG. 16, the offer engine may be a food offer engine 1610.

The food offer engine 1610 may take several factors into consideration. For example, the food offer engine 1610 considers the user's location 1615a, nearby restaurants 1615b, the user's route 1615c, favorite food categories 1615d, favorite restaurants 1615e, and time of day 1615f. The food offer engine 1610 may first determine if the user is authorized 1610a. The food offer engine 1610 may then determine the time of day for the offer 1610b. The food offer engine 1610 may then determine restaurants with favorite food categories nearby 1610c. The food offer engine 1610 may then determine what restaurants ahead are on the user's route 1610d. If the restaurants ahead are on the user's route, the food offer engine 1610 may determine if favorite restaurants are nearby 1610e. If favorite restaurants are nearby, the food offer engine 1610 may generate an offer with an option of promoting favorite restaurants ahead. If favorite restaurants are not nearby, the food offer engine 1610 may generate an offer with the option of highlighting restaurants ahead.

If restaurants ahead are not on the user's route the food offer engine 1610 may determine if any favorite restaurants are nearby 1610f. If favorite restaurants are nearby, the food offer engine 1610 may generate an offer with an option of highlighting the user's favorite restaurants. If the favorite restaurants are not nearby, the food offer engine 1610 may generate offers sparingly.

The user may then decide to either accept or reject the promotion 1625. On a condition the user does not accept the promotion 1620, the user may go back to driving and using navigation or listening to media.

On a condition that the user accepts the promotion, the user is redirected to an order screen and may review menu items to make a purchase decision 1630. The user may select at least one item from the vendor 1635. The user may then use PIN, voice, or biometrics to access a wallet 1640. The user may then make a payment for the at least one item using the wallet 1645. The user may receive loyalty points for the purchase 1650.

The user may then receive a routing update to the vendor's location to retrieve the item 1655. The user may then arrive at the vendor's location and break the geofence 1660. The vendor may receive a notification that the user has arrived 1665. The vendor may then bring the item to the user or the user may receive pickup instructions 1670.

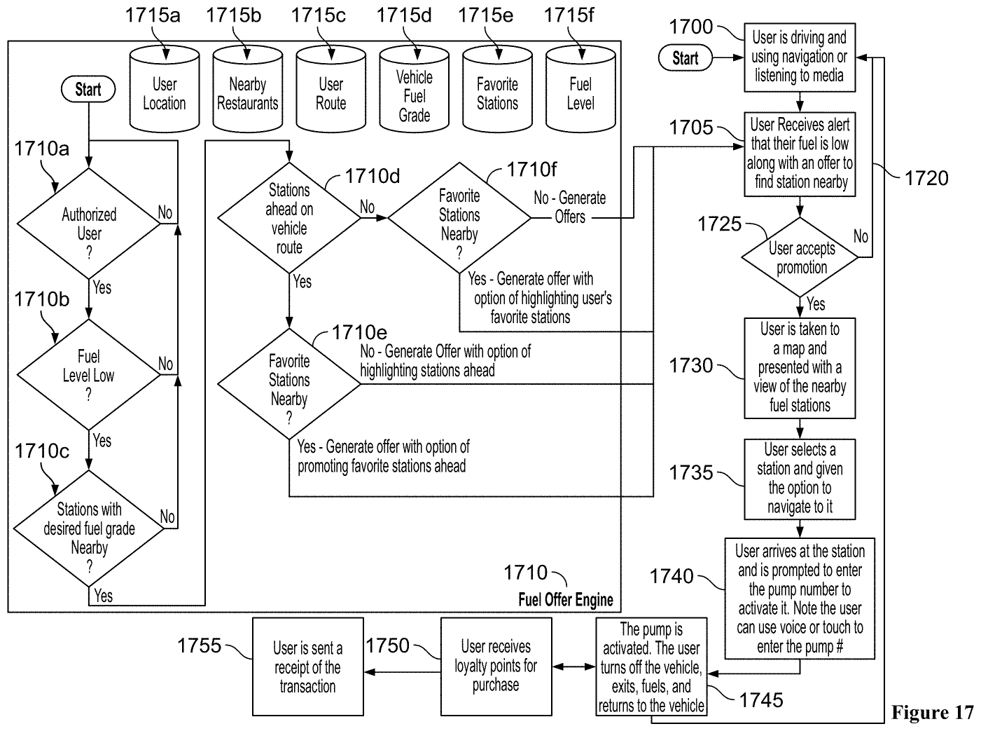

FIG. 17 is a second example flow diagram of contextual promotion followed by an in-vehicle purchase. A driver may be driving and using the navigation or listening to media 1700. The driver may receive an alert that their fuel is low along with an offer to find a fuel station nearby 1705.

The fuel offer engine 1710 may take several factors into consideration. For example, the fuel offer engine 1710 considers the user's location 1715a, nearby stations 1715b, user's route 1715c, vehicle fuel grade 1715d, favorite stations 1715e, and fuel level 1715f. The fuel offer engine 1710 may first determine if the user is authorized 1710a. The fuel offer engine 1710 may then determine if the fuel level is low 1710b. The fuel offer engine 1710 may then determine stations with desired fuel grade nearby 1710c. The fuel offer engine 1710 may then determine what stations ahead are on the user's route 1710d. If the stations ahead are on the user's route, the fuel offer engine 1710 may determine if favorite stations are nearby 1710e. If favorite restaurants are nearby, the fuel offer engine 1710 may generate an offer with an option of promoting favorite stations ahead. If favorite stations are not nearby, the fuel offer engine 1710 may generate an offer with the option of highlighting stations ahead.

If stations ahead are not on the user's route the fuel offer engine 1710 may determine if any favorite stations are nearby 1710f. If favorite stations are nearby, the fuel offer engine 1710 may generate an offer with an option of highlighting the user's favorite stations. If the favorite stations are not nearby, the fuel offer engine 1710 may generate offers sparingly.

The user may then decide to either accept or reject the promotion 1725. On a condition the user does not accept the promotion 1720, the user may go back to driving and using navigation or listening to media.

On a condition that the user accepts the promotion, the user is redirected to a map and presented with a view of the nearby fuel stations 1730. The user may select a station and is given the option to navigate to it 1735. The user may then arrive at the station and be prompted to enter the pump number to activate it 1740. The user may use voice or touch to enter the pump number. The pump may then be active. The user may then turn off the vehicle, exit the vehicle, fuel the vehicle, and return to the vehicle 1745. The user may receive loyalty points for the purchase 1750. The user may then be sent a rescript of the transaction 1755.

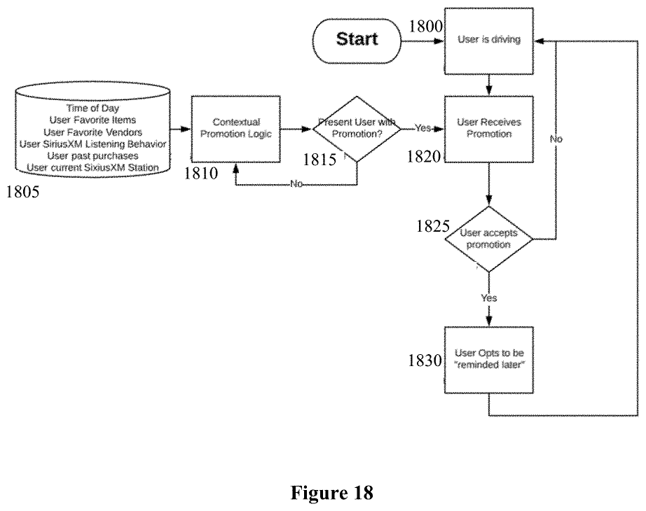

FIG. 18 is an example flow diagram of a contextual promotion followed by a “remind me later” link. A user may be driving in a vehicle 1800. The driver may receive a promotion 1820. When the driver receives the promotion, several factors 1805 are taken into consideration. For example, the factors 1805 may include the time of day, the user's favorite items, the user's favorite vendors, the user's SiriusXM listening behavior, the user's most recent purchases, and the user's current SiriusXM station. Based on all of these factors 1805, contextual promotion logic 1810 is utilized. A determination is then made whether to present the user with a promotion 1815. On a condition that the answer is yes, then the user receives a promotion 1820. On a condition that the answer is no, then contextual promotion logic is tried again 1810.

Once the user receives the promotion 1820, the user may either accept or reject the promotion 1825. On a condition that the user accepts the promotion, the user may opt to be “reminded later” 1830 and the user may continue driving 1800 and await further promotions. The promotion is saved to the user's account where they may view the promotion at their leisure and determine if they would like to make the purchase. On a condition that the user reject the promotion, the user may continue driving 1800 and await further promotions.

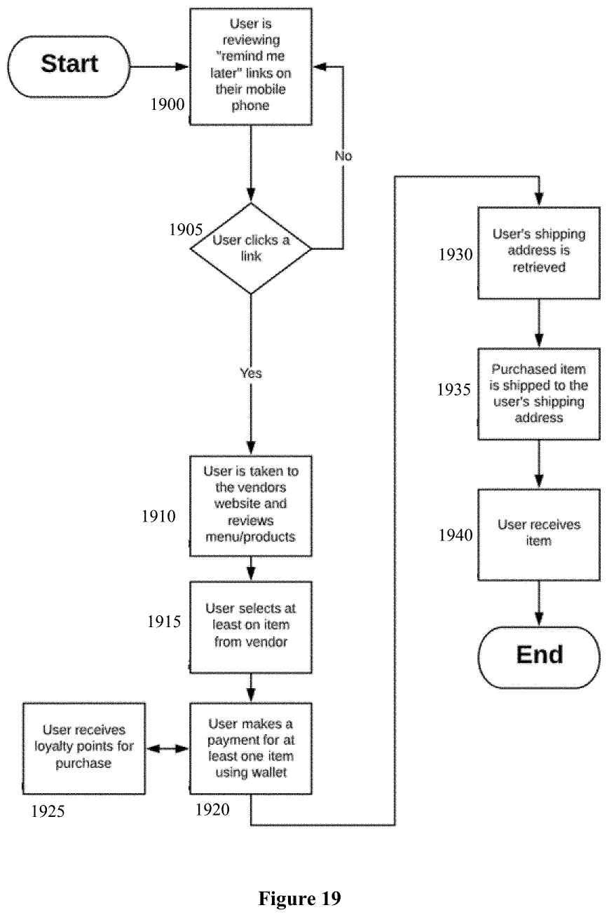

FIG. 19 is an example flow diagram of a “remind me later” purchase. The user may review a “remind me later” link on their mobile phone 1900. The user may decide to click the link 1905. On a condition that the user does not click the link, the user may review other “remind me later” links.

On a condition that the user clicks the link, the user may be redirected to the vendor's website and may review the menu/products. 1910. The user may select at least one item from the vendor 1915. The user may make a payment for the at least one item using the wallet 1920. The user may receive loyalty points for the purchase 1925. The user's shipping address may be retrieved 1930. The purchased item may be shipped to the user's shipping address 1935. The user may then receive the item 1940.

What is claimed:

1. A method for making in-vehicle purchases from received contextual promotions, the method comprising:
receiving an in-vehicle promotion from an offer engine, wherein offer engine determines the in-vehicle promotion based on a time of day, a user's location, the user's route, nearby vendors, the user's favorite items, and the user's favorite vendors;
accepting the received in-vehicle promotion;
selecting at least one item for purchase from a vendor;
making a payment for the at least one item using an e-wallet;
receiving a routing update to a location of the vendor;
breaking a geofence at the location of the vendor; and
picking up the at least one purchased item at the location of the vendor.

2. The method of claim 1, wherein the offer engine is a food offer engine.

3. The method of claim 1, wherein the offer engine is a fuel offer engine.

4. The method of claim 1, wherein the at least one item for purchase is selected from a list of favorite items.

5. The method of claim 1, wherein access to the e-wallet requires at least one of a personal identification number (PIN), touch, and biometrics.

6. The method of claim 1, further comprising:
receiving an arrival message as the vehicle approaches the location of the vendor.

7. The method of claim 1, wherein the vendor is a user-defined favorite vendor.

8. A method for receiving an in-vehicle promotion including a “remind me later” link, the method comprising:
receiving at least one in-vehicle promotion with a “remind me later” link from a vendor, wherein the in-vehicle promotion is based on a time of day, a user's favorite items, the user's favorite vendors, the user's radio listening behavior, the user's past purchases, and the user's current radio station;
accepting the at least one in-vehicle promotion and opting to be “reminded later”;
transmitting the at least one in-vehicle promotion to a companion application of a mobile phone app of the user;
accessing the at least one in-vehicle promotion in the companion application; and
making a purchase for a product at a vendor's website based on the at least one received in-vehicle promotion.

9. The method of claim 8, wherein the companion application stores all “remind me later” links.

10. The method of claim 8, wherein the at least one “remind me later” link includes vendor and timestamp information.

11. The method of claim 8, wherein the companion application adds tags to the Uniform Resource Locator (URL) to ensure accurate tracking and revenue credit.
